(19) United States
(12) Patent Application Publication
(10) Pub. No.: US 2015/0231946 A1
(43) Pub. Date: Aug. 20, 2015

(54) NOISE ATTENUATED AIR DUCT

(71) Applicant: Unique Fabricating, Inc., Auburn Hills, MI (US)

(72) Inventor: Daniel Bianchi, Auburn Hills, MI (US)

(73) Assignee: Unique Fabricating, Inc., Auburn Hills, MI (US)

(21) Appl. No.: 14/621,990

(22) Filed: Feb. 13, 2015

Related U.S. Application Data
(60) Provisional application No. 61/939,933, filed on Feb. 14, 2014.

(51) Int. Cl. B60H 1/00; F24F 13/02

(52) U.S. Cl. CPC B60H 1/00564; F24F 13/0245

(57) ABSTRACT

An air duct having an outer surface enclosing an inner space, said inner space in contact with an inner surface of said air duct; said inner surface equipped with air flow obstacles or impediments to create eddys and back flows and reduce noise transmission of air as it travels along the length of the duct.

### CROSS-REFERENCE TO RELATED APPLICATION

This application claims priority to provisional patent application No. 61/939,933 filed on Feb. 14, 2014, which is hereby incorporated by reference in its entirety.

### TECHNICAL FIELD

The disclosure is related to an air duct system with noise attenuation properties.

### BACKGROUND

Air ducts, especially in vehicular applications, exhibit certain noise properties that, in the past, have been difficult to attenuate. Air traveling along the hollow body of an air duct creates a “whooshing” noise. In applications outside of the automotive or vehicular industry, such as the construction industry, it was possible to insulate the outside of the air duct or to hide the air duct in construction of a building such that the noise was not noticed by occupants. In automotive applications, air ducts are short and surrounded by an acoustical attenuating layer, such as foam, do not necessarily meet the requirements for noise attenuation because noise in the air duct is a function of the travel of air along the air duct passage that can create a low frequency “whooshing” noise.

There is a need for an air duct for use in automotive or vehicular applications that does not take any additional space in the vehicle and attenuates the air duct noise issue.

### SUMMARY

It has been found that noise attenuation properties can be imparted to an automotive air duct when small obstacles or small impediments to the flow of air along the inner surface of the air duct are added to an inner surface of the air duct. The impediments can include structures such as cross hatched surfaces, cilia like structures, and/or textures like a fabric or carpet surface that can be introduced along the inner surface of the air duct.

### BRIEF DESCRIPTION OF THE DRAWINGS

FIG. 1 is a detailed view of an assembled automotive air duct according to one embodiment of the disclosure;

FIG. 2A is a sectional view of another non-limiting embodiment of the air duct with noise attenuation;

FIG. 2B is a sectional view of another non-limiting embodiment of the air duct with noise attenuation;

FIG. 2C is a sectional view of another non-limiting embodiment of the air duct with noise attenuation; and

FIG. 2D is a sectional view of another non-limiting embodiment of the air duct with noise attenuation.

### DETAILED DESCRIPTION

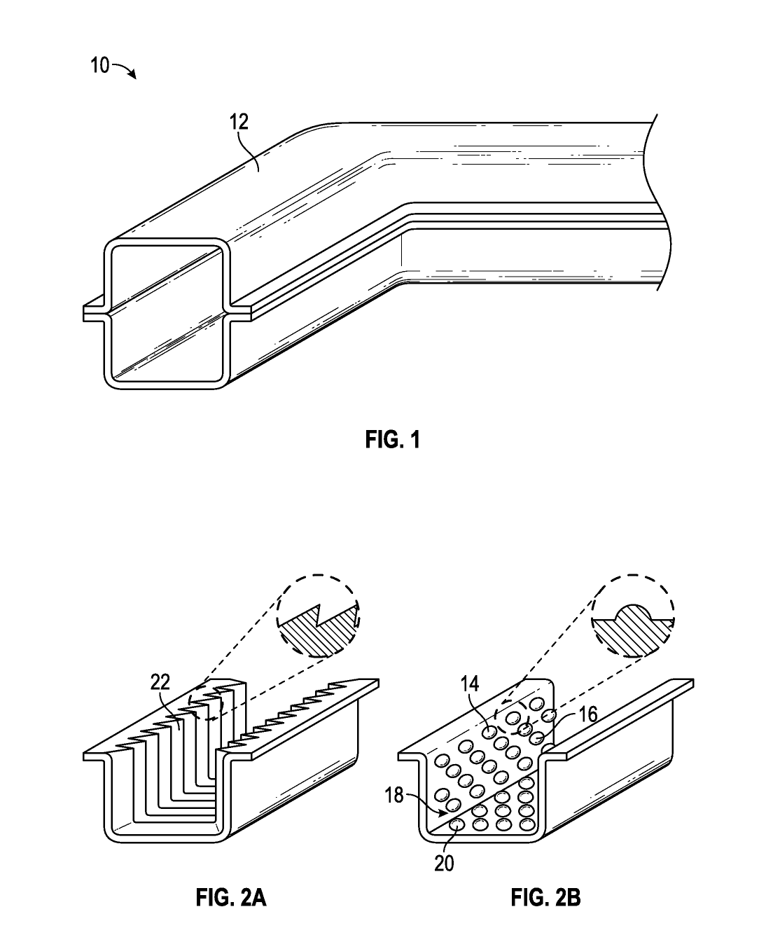

Turning now to FIG. 1, an air duct 10 has a hollow body with an outer surface 12 and an inner space that is or is in contact with an inner surface 14. Many materials may be suitable for manufacturing air duct 10, including instances where a material or combination of materials on the outer surface 12 is different from the material or combination of materials on the inner surface 14. Outer surface 12 may be constructed of a rigid material, such as, for example, a hard plastic material such ABS or other plastic material such as is generally known and used in the art. Closed cell foam materials may also be used, possibly joined together by one or more of welding or twin sheet forming.

Air duct 10 can be used in many applications, including automotive and vehicular applications, such as cars, trucks, boats, busses, airplanes and recreational vehicles. Applications for air duct 10 may also include buildings and construction, or other applications where noise attenuation is a manufacturer and/or a customer preference or an industry requirement.

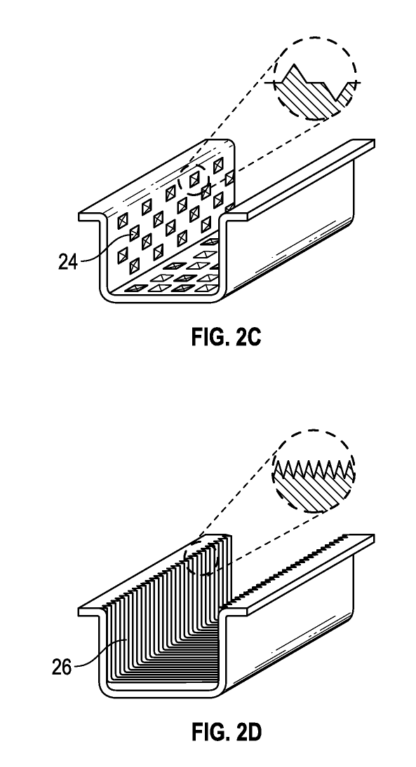

In the examples illustrated in FIGS. 2A-2D, the inner surface 14 is modified with one or more impediments or combinations of the same or different impediments. The impediments may include a textured contour 16, which may be impediments 18, such as protrusions, for example, bumps 20, ripples 22 or cross hatch surfaces 24, or textured fabric like surface 26, such as, for example a carpet-like textured surface. Other impediments are contemplated, including cilia or hair-like structures. Such cilia-like structures may be formed from one or more natural or synthetic material, including fibers. Such structures may be of a variety of thicknesses and lengths, may be round or flat, and may dispersed throughout at least a portion of the inner surface 14 in a dense manner or in a sparse manner. In one embodiment, the structures may be dispersed through the entirety of the inner surface 14. As air flows along the inner surface 14 of the air duct 10, as indicated by arrow 28, it encounters the impediments, and breaks into a number of individual and small air flow currents and eddys, respectively.

In one exemplary embodiment, impediments 18 may have a height or amplitude of up to about 4 mm. In one exemplary embodiment, impediments 18 may have a distance between other impediments 18 (wavelength) of about 1 to about 3 mm. Air duct 10 may have uniformly distributed impediments 18, or the distribution of impediments may be irregular. Combinations of different impediments (whether different in one or more of size, shape or material) may be incorporated into a single air duct 10.

The impediments 18 can be formed in any of a number of methods, including separately forming a layer having one or more impediments, and adhering (physically or chemically or both) such layer inside the inner space of air duct 10 to form inner surface 14. Such may be done before forming or shaping the air duct 10, while forming or shaping the air duct 10 or thereafter. Depending upon the sort of impediments being used, some may be formed together with the manufacturing process for forming the air duct 10 using, for examples, molds. Additionally, such impediments may be formed by texturing a material using an abrasive tool or other method, causing a starting surface to become rougher and/or more uneven.

Without being bound by theory, it is believed that the breaking of the air flow causes the air to swirl back against the air flow. The combination of these factors may attenuate the noise associated with air as it travels along the inner surface of the air conduit. Such reduction in noise transmission may be discernible by comparison to a reference air duct. A reference air duct would be of the same or substantially the same construction (shape and materials) as an air duct 10 described herein except the reference air duct would be free from impediments 18 as described herein. The differences may be audible to a human ear, or may otherwise be measured using engineering equipment and methods.

With regard to the processes described, it should be understood that, although the steps of such processes have been described as occurring in a certain sequence, such processes could be practiced with the described steps performed in an order other than the order described. It should be understood that certain steps could be performed simultaneously, that other steps could be added, or that certain steps described herein could be omitted.

The entirety of the above description is intended to be merely illustrative. Many embodiments and applications other than the examples provided would be apparent upon reading the above description. The scope of the invention should be determined with reference to the appended claims along with the full scope of equivalents to which such claims are entitled. It is anticipated that future developments will occur in the described technologies, and that the disclosed devices and processes will be incorporated into such future embodiments. That is, the invention is capable of variation.

All terms used in the claims are intended to be given their ordinary meanings as understood by those knowledgeable in the described technologies unless an explicit indication to the contrary is made. Also, singular articles such as “a,” “the,” “said,” should be understood to recite one or more of the indicated nouns unless a claim explicitly recites otherwise.

1. An air duct, comprising:
an outer surface; and
an inner surface having air flow impediments on at least a portion of the inner surface in an arrangement sufficient to reduce noise transmission of air as it travels through the duct relative to a reference air duct of identical materials and shape, the reference air duct lacking air flow impediments.

2. The air duct of claim 1, wherein said inner surface is equipped with cross hatching along at least a part of the inner surface.

3. The air duct of claim 1, wherein said inner surface is equipped with ripples along at least a part of the inner surface.

4. The air duct of claim 1, wherein said inner surface is textured to have a fabric like finish.

5. The air duct of claim 1 wherein the outer surface and the inner surface are formed from the same material.

6. The air duct of claim 1 wherein the outer surface and the inner surface are formed from the different materials.

7. A method of forming a noise-attenuating air duct, comprising:
shaping plastic or form material into an air duct having an outer surface and an inner space; and
modifying the inner space of the air duct to include a plurality of air flow impediments.

8. The method of claim 7 wherein the shaping step includes twin sheet forming foam sheets.

9. The method of claim 7 wherein the modifying step includes texturing the inner space of the air duct to create a rough surface.

10. The method of claim 7 wherein the modifying step includes adhering a layer of material having air flow impediments to the inner space to form an inner surface of the air duct.

11. The method of claim 7 wherein the modifying step is performed simultaneously with the shaping step by twin sheet forming the air duct while using a mold to form the plurality of air flow impediments.

12. The method of claim 7 wherein the plurality of air flow impediments comprise ripples.

13. The method of claim 7 wherein the plurality of air flow impediments comprise cross hatch surfaces.

14. The method of claim 7 wherein the plurality of air flow impediments comprise textured fabric.

15. The method of claim 7 wherein the plurality of air flow impediments comprise cilia-like structures.

16. An automotive air duct, comprising:
a hollow body with an outer surface and an inner surface; and
a plurality of air flow impediments through at least a portion of the inner surface of the air duct, such air flow impediments comprising spaced apart protrusions extending inwardly to no more than about 4 mm.

17. The automotive air duct of claim 16 further wherein the plurality of air flow impediments are dispersed throughout an entirety of the inner surface of the air duct, the spacing between individual impediments ranging from about 1 mm to about 3 mm.

18. The automotive air duct of claim 17 further wherein the plurality of air flow impediments are dispersed in a regular pattern.

19. The automotive air duct of claim 17 further wherein the plurality of air flow impediments are dispersed in an irregular pattern.
